(19) United States
(12) Patent Application Publication
(10) Pub. No.: US 2019/0249100 A1
(43) Pub. Date: Aug. 15, 2019

(54) METHOD FOR IMPROVING TRANSPORT AND HANDLING OF DUST EMITTING SOLIDS MATERIALS

(71) Applicant: General Electric Company, Schenectady, NY (US)

(72) Inventors: Umit Turunc, Trevose, PA (US); Michael T. Raab, Trevose, PA (US); David A. Undlin, Spearfish, SD (US); Bryce Anden Uytiepo, Blue Bell, PA (US)

(73) Assignee: General Electric Company, Schenectady, NY (US)

(21) Appl. No.: 16/333,399

(22) PCT Filed: May 10, 2017
(86) PCT No.: PCT/US2017/031844

§ 371 Date: Mar. 14, 2019

Related U.S. Application Data
(60) Provisional application No. 62/394,421, filed on Sep. 14, 2016.

(51) Int. Cl. C10L 5/24; C09K 3/22; C10L 10/02

(52) U.S. Cl. CPC C10L 5/24; C10L 5/04; C10L 10/02; C09K 3/22

(57) ABSTRACT

Methods are provided for controlling fugitive dust emissions from a variety of granular or particulate solids materials such as coal dust. A first treatment of cationic polymer or cationic copolymer is applied to the dust. The dust is then loaded onto an open bed rail car or the like. A topping treatment comprising an aqueous dilute polymer solution or polymer latex emulsion or dispersion is applied to the exposed coal layer in the rail car.

### FIELD OF INVENTION

The present invention pertains to methods for inhibiting dust emission from a variety of dust emitting granular or particulate solids materials as same are handled or transported. The invention is of particular advantage in inhibiting dissemination of coal dust during transit.

### BACKGROUND OF THE INVENTION

Dust dissemination poses safety, health, and environmental problems in many commercial environments. For instance, in many industries, the transportation, handling, and storage of bulk solids is common as in industries such as mining, mineral processing, agricultural, power, steel, paper, etc. One major problem associated with bulk solids is dust generation and the control of fugitive dust emissions.

Industrial sources of fugitive dust include open operations, leaks and spills, storage, disposal, transit, or poor housekeeping of sundry finely divided solid particulates. The iron and steel industries are replete with examples of the above enumerated categories. Wind erosion of exposed masses of particulate matter such as coal or mine mill tailings, fertilizer, etc., causes both air pollution and economic waste. Detrimental effects on health and cleanliness result where these fine particles are carried aloft by the winds.

In the coal mining industry, coal dust dissemination may occur during coal pile storage or when the coal particles are transported via rail or the like from the mining site to a usage site, such as a power plant, wherein the coal is then burned as fuel.

### SUMMARY OF THE INVENTION

The present invention utilizes the combination of body feed dust control treatment added to the particulate dust disseminating solids prior to the loading of same onto a transit vehicle such as a rail car. Then, a topping treatment consisting of a polymer or latex is added to the top of the particulate mass in the transport vehicle.

With respect to coal mining operations, current technology uses latex type crusting agents to reduce fugitive dust from coal cars. This requires, per rail car, up to 10 pounds of latex in water solution to be applied to give a significant fugitive dust reduction. In one embodiment, the invention uses a body fed binder of a cationic polymer applied to the coal prior to loading of the coal into the rail cars, and once the coal is loaded into the rail car, applying onto the top of the coal mass in the rail car a solution of polymer or latex at significantly lower concentrations than currently used.

In one aspect, the invention requires application of no more than three pounds of polymer or latex per rail car to reduce fugitive coal dust, preferably one to two pounds of polymer or latex per rail car.

The combination of body feed of dust control to the coal prior to loading into the rail cars, and followed by one to three pounds of latex in solution applied on to the top of the coal mass in the rail car give effective fugitive dust control from the coal during transportation, at significantly lower cost.

In one exemplary embodiment, methods are provided for suppressing fugitive dust emission from a granular or particulate solid material, such as coal dust, comprising the steps of:

(1) applying a cationic polymer or copolymer to the solid material;

(2) loading the solid material from the previous step into a transport vehicle such as an open bed rail car; and

(3) applying a topping treatment of polymer to the solid material. In a certain aspect of the invention, the topping treatment comprises either an aqueous solution of water soluble polymer or a latex emulsion or dispersion of polymer.

After treatment, in accordance with (1)-(3) above, the granular or particulate solid material exhibits greater than about 85% improvement in dust suppression when compared to untreated samples of the granular or particulate solids under wind conditions of 35-45 mph for five minute test duration.

In some cases, the solid granular particulate material may comprise coke, urea, mineral ores, mineral concentrates, fly ash, coal combustion residue, phosphate rock, fertilizer, limestone, crushed stone, aggregate, sand, wood chips, waste derived fuel, hog fuel, iron ore pellets, and coal.

In certain embodiments, the topping treatment can be applied over an exposed layer of coal disposed in a rail car in an amount of less than about three gallons (actives) topping treatment per rail car.

The cationic polymer or copolymer applied as per step (1) above may comprise a member selected from the group consisting of polyamines, polyquaternary ammonium polymers, and copolymers, melamine/formaldehyde polymers, diallyldimethyl ammonium chloride polymers, di-ethylene-triamine/adipic acids/epichlorohydrin polymers, amino-methylated polyacrylamide and cationic copolymers of acrylamide.

The cationic polymer or copolymer applied to the dust as per step (1) may comprise a foam including water, foaming agent, and cationic polymer or copolymer. In some instances, the foam is fed at a weight percent of about 0.05-30.0% of the foam per ton of the dust to be treated. In some embodiments, the foam contains about 0.05-20% by weight of the cationic polymer or copolymer.

In some embodiments, the topping treatment is sprayed onto an exposed layer of coal dust at a rate of about 1-3 gallons of the topping treatment per rail car as measured on an actives basis of the topping treatment.

In certain aspects of the invention, the topping treatment comprises a member selected from the group consisting of styrene-acrylic copolymers, styrene-butadiene copolymers, vinyl acrylic copolymers, acrylic polymers, methacrylate-acrylate ister copolymers, polyvinyl acetate polymers, ethylene-polyvinyl acetate copolymers, vinyl acetate-acrylic copolymers, and polyacrylamide polymers and copolymers.

In certain aspects of the invention, the cationic polymer or copolymer is an amino methylated polyacrylamide or the cationic polymer or copolymer may be a diethylene-triamine/adipic acid/epichlorohydrin polymer. Further, in certain embodiments, the topping treatment may comprise a latex emulsion or dispersion comprising ethylene-polyvinyl acetate copolymer.

### DETAILED DESCRIPTION

In accordance with one exemplary embodiment, methods are provided for suppressing fugitive air borne dusts from a variety of finely divided particulate or granular materials. Although the invention will deal mainly with dust suppression of coal dust particles, the artisan will appreciate that the solid particulate or granular dusts to be treated can comprise a variety of particles such as coke, urea, mineral ores, mineral concentrates, fly-ash, coal combustion residue (CCR), phosphate rock, fertilizers, limestone, crushed stone, aggregates, sand wood chips, waste derived fuels (WDF), hog fuel, and iron ore pellets.

One aspect of the invention is directed to a two step dust dissemination suppression treatment wherein a body feed treatment of dust control additive is made prior to the loading of the dust into a transport vehicle such as a rail car or truck. Then, about 1-3 pounds of a latex based “topper” treatment is applied to the dust prior to or upon loading of the dust to the transport vehicle. In most cases, the “topper” treatment is made to the dust particles after same have been loaded to a rail car, and the “topper” treatment is made, as the name suggests, to the top layer of exposed coal lying in the rail car.

In some aspects of the invention, foamed application of a cationic polymer or polymers is first made as the “body treatment” followed by a “topper” application to the so-treated dust particles. The cationic polymers or cationic copolymers can be chosen from a wide variety of material including, but not limited to, water soluble polymers and copolymers of
Polyamines and polyquaternary ammonium salts
Melamine/formaldehyde polymer
Diallydimethyl ammonium chloride polymer
Diethylene-triamine/adipic acid/epichlorohydrin polymer (preferred material)
Amino-methylated polyacrylamide (preferred material)
Cationic copolymers of acrylamide

After application of “body feed” and placement of coal into the rail car, car topper material is applied as a dilute solution in water, at the rate of less than three pounds per rail car of car topper material, preferably one to two pounds per rail car (actives basis of polymer in latex emulsion or dispersion). The solution application rate of the dilute car topper material will be in the range of 10 to 25 gallons/rail car, preferably 15 to 20 gallons/rail car.

Car topper materials can include polymeric solutions or latex emulsions or dispersion comprising, but not limited to the following polymers:
Styrene-acrylic copolymers
Styrene-butadiene copolymers
Vinyl-acrylic copolymers
Acrylic polymers
Methacrylate-acrylate ester copolymers
Polyvinyl acetate polymers
Ethylene-polyvinyl acetate copolymers (preferred material)
Vinyl acetate-acrylic copolymers
Polyacrylamide polymers and copolymers

In some aspects of the invention, the body feed treatments are applied in foam form. The body feed water soluble cationic polymers or copolymers may be supplied initially in concentrate form which is then diluted prior to application as a foam. The body feed treatment concentration, in percent cationic polymer by weight foam, can range from about 0.05% to 20.0%0/and is preferably from about 0.1 to 10.0%. The feed rate of foam onto the substrate, on a weight percent basis, can range from about 0.05 to 30.0% and is preferably from about 0.1 to 15.0%.

The foam for the body feed dust control treatment may be formed and applied via conventional techniques such as those disclosed in U.S. Pat. No. 4,440,220 (Cole), the contents of which are hereby incorporated by reference. A suitable foaming agent and water are included in the body feed treatment. The foaming agents may be anionic, cationic, or amphoteric. One particularly noteworthy anionic surfactant is a C₁₄-C₁₆ alpha olefin sulfonate.

### Examples

In order to assess the efficacy of the treatment methods in coal dust emission, the following tests were performed using the procedure set forth below.

### Laboratory and Test Method:

### Sample Collection and Preparation:

Coal samples were obtained from the mine site either not treated with “body-feed” as controls or treated with “body-feed”. Prior to application of car-topper treatment, the coal is screened to ½ inch×0 (½″ minus). Only the minus ½ fraction is used for the test.

### Topper Treatment:

Approximately eight pounds of the coal is placed in a sample tray (14.5″×10.5″×2″ deep). The sample tray is placed on a guide rail assembly, wherein the tray is horizontally moved at fixed speed under a fixed spray nozzle, via a servo-motor and pulley. The topper treatment solution is sprayed across the width of the sample while the tray is moved along the guide rail. The entire topper treatment solution is applied in a single coat. The spray system has an adjustable pump that can vary the spray rate to provide equivalent of 10 to 30 gallons/rail-car of topper solution.

### Solar Stress and Driving:

After topical treatment, the tray is placed directly under heat lamps to simulate solar stress. After heating the sample for a minimum of two hours, the tray continues to dry overnight (for 12 to 16 hours).

### Wind Tunnel Test:

The sample tray is positioned in the middle of a 48″×12″×12″ (L×W×H) Wind Tunnel. The air current is created by an electric blower at the inlet of the wind tunnel. The tray is placed on an angle so that the entire surface is subject to the air current. A turbine-type anemometer is used to measure the actual wind speed in the tunnel during the test. At the exit of the tunnel, a (pre-weighed) pleated fabric filter is used to collect any airborne dust that is dislodged from the sample tray. At the end of the test, the dust on the filter is weighed and recorded. Wind tunnel test duration was 300 seconds, at a wind speed of 35 to 45 mph.

Results are shown in Table 1:

TABLE 1
40 mph for 300 seconds

| | Dust Collected (g) | % Dust Suppression |
|---|---|---|
| Untreated Powder | 35 | 0.0% |
| River Basin Coal | | |
| Bodyfeed | 21 | 40.0% |
| 0.2 gals/car Topper | 6 | 82.9% |
| without Bodyfeed | | |
| Bodyfeed + 0.2 | 1 | 97.1% |
| gal/car Topper | | |

“Bodyfeed” = amino methylated polyamine
Cationic polymer and C₁₄-C₁₆ alpha olefin sulfonate surfactant (foaming agent) ≈ 1:1 actives bases; foamed solution is fed to coal at about 1.0 wt % solution in water
Topper = vinyl acetate/ethylene copolymer latex (VA)

Standard latex emulsion or dispersion polymers applied as dust control agents require up to 10 pounds latex per rail car. Certain aspects of the present invention, however, require only one to three pounds of latex solution applied to the top of the coal mass in the rail car when combined with a prior body feed application of cationic polymer or copolymer. This represents considerable cost savings.

From the above example, in one embodiment, the combination of body feed treatment followed by topper treatment results in percent dust suppression of greater than 85% when compared to untreated coal dust samples. Indeed, as per the above example, greater than 95% dust suppression can be achieved in some instances under wind speed conditions of 35-45 mph for five minutes.

While the present invention has been described with respect to particular examples, it is apparent that numerous other form and modifications of the invention will be obvious to those skilled in the art. The appended claims and this invention should be construed to cover all such obvious forms and modifications which are within the spirit and scope of the present invention.

1. Method for suppressing fugitive duct emission from a granular, or particulate solid material comprising:
(1) applying a cationic polymer or copolymer to said solid material;
(2) loading said solid material from said step (1) into a transport vehicle, and
(3) applying a topping treatment of polymer to said solid material.

2. A method as recited in claim 1 wherein said topping treatment comprises an aqueous solution of water soluble polymer or a latex emulsion or dispersion of polymer.

3. A method as recited in claim 1 wherein after said step (3), said granular or particulate solid material exhibits greater than 85% improvement in dust suppression when compared to untreated samples of said granular or particulate solids under wind conditions of 35-45 mph for five minutes.

4. A method as recited in claim 3 wherein said improvement in dust suppression is greater than 95%.

5. A method as recited in claim 2 wherein said solid material comprises a granular or particulate material chosen from coke, urea, mineral ores, mineral concentrates, fly ash, coal combustion residue, phosphate rock, fertilizer, limestone, crushed stone, aggregate, sand, wood chips, waste derived fuel, hog fuel, iron ore pellets, and coal.

6. A method as recited in claim 5 wherein said solid material is coal dust and said transport vehicle is a rail car; said step (3) comprising application of said topping treatment over an exposed layer of said coal disposed in said rail car in an amount of less than about three gallons of said polymer latex emulsion or dispersion per rail car.

7. A method as recited in claim 6 wherein said step (1) comprises applying a foam containing said cationic polymer or copolymer to said coal dust, said cationic polymer or copolymer comprising a member selected from the group consisting of polyamines, polyquaternary ammonium polymers, and copolymers, melamine/formaldehyde polymers, diallyldimethyl ammonium chloride polymers, di-ethylene-triamine/adipic acids/epichlorohydrin polymers, amino-methylated polyacrylamide and cationic copolymers of acrylamide.

8. A method as recited in claim 7 wherein said foam containing said cationic polymer or copolymer is fed to said coal dust at a weight percent of about 0.05-30.0% of said foam per ton of said coal dust.

9. A method as recited in claim 8 wherein said foam contains about 0.05-20.0% by weight of said cationic polymer or copolymer.

10. A method as recited in claim 9 wherein in said step (3) said topping treatment is sprayed onto said exposed layer of coal dust at a rate of about 1-3 gallons of said topping treatment (actives basis) per rail car.

11. A method as recited in claim 10 wherein said topping treatment comprises a member selected from the group consisting of styrene-acrylic copolymers, styrene-butadiene copolymers, vinyl acrylic copolymers, acrylic polymers, methacrylate-acrylate ister copolymers, polyvinyl acetate polymers, ethylene-polyvinyl acetate copolymers, vinyl acetate-acrylic copolymers, and polyacrylamide polymers and copolymers.

12. A method as recited in claim 11 wherein said cationic polymer or copolymer is an amino-methylated polyacrylamide.

13. A method as recited in claim 11 wherein said cationic polymer or copolymer is a diethylene-triamine/adipic acid/epichlorohydrin polymer.

14. A method as recited in claim 11 wherein topping treatment is a said latex emulsion or dispersion comprising ethylene-polyvinyl acetate copolymer.
